(19) United States
(12) Patent Application Publication
(10) Pub. No.: US 2021/0403231 A1
(43) Pub. Date: Dec. 30, 2021

(54) STRUCTURED COVERS

(71) Applicant: Serena Roberge-Gordon, Vancouver, WA (US)

(72) Inventor: Serena Roberge-Gordon, Vancouver, WA (US)

(21) Appl. No.: 17/336,568

(22) Filed: Jun. 2, 2021

Related U.S. Application Data
(60) Provisional application No. 63/043,599, filed on Jun. 24, 2020.

(51) Int. Cl. B65D 90/06; D07B 1/14

(52) U.S. Cl. CPC B65D 90/06; B60P 7/0876; D07B 2401/2005; D07B 1/14

(57) ABSTRACT

Structured covers including an expanse, a structure member, and a hook. The hook is coupled to a first end of the structure member, The hook is configured to selectively couple to a coupling member to bound the expanse in a defined configuration defined at least in part by the structure member. In some examples, the structured cover includes a plurality of structure members, a plurality of mounting points, a channel layer, a crimp, and/or a reinforcing layer.

This application claims priority to copending U.S. Application Ser. No. 65/043,599, filed on Jun. 24, 2020, which is hereby incorporated by reference for all purposes.

The present disclosure relates generally to non-bedding covers. In particular, covers with structure to secure around items more effectively arc described.

Covers are ubiquitous in modern society and have a variety of practical uses. Covers may be used to conceal items, to secure items in place, and to protect items from the elements, among many other uses. Covers used to conceal, secure, and protect items, especially waterproof covers, are often called tarps even though the covers may not be formed from tarpaulin. This document will refer to covers and tarps interchangeably.

Known covers are not entirely satisfactory for the range of applications in which they are employed. For example, existing covers do not maintain a configuration closely conforming to the shape of the items they are covering. Instead, conventional covers tend to only partially conform to the shape of the items they are covering or require accessory cords or fasteners to maintain them in a closely conforming configuration. Accessory cords and fasteners can be awkward to use or not readily available, which makes them inconvenient.

In addition, conventional covers do not secure to mounting points easily or effectively. Often, one will desire to secure a cover over an item in a desired position on the ground, on a structure, or on a vehicle. Existing covers generally require one to use accessory cords or fasteners to secure them in place. However, accessory cords arc fasteners arc not always available, may not lie compatible to secure the cover to a desired mounting point, and/or may be inconvenient to use.

Another limitation of existing covers is that they do not facilitate distributing tension and compression forces of accessory fasteners over a wider area of the cover. Too often, a relatively small number of accessory cords or fasteners will exert tension and compression forces at a few localized points on the cover, such as along the outer edges, on one or more comers, or across rite cover in a concentrated line. The tension and/or compression forces needed to secure the cover in position can be significant, such as in windy environments. Exerting the requisite tension and/or compressive forces necessary to secure the cover in position in a few localized places can cause the cover to rear or otherwise fail at those localized positions. The forces can also damage the item covered by the cover.

Thus, there exists a need for covers that improve upon and advance the design of known covers. Examples of new and useful covers relevant to the needs existing in the field are discussed below.

### SUMMARY

The present disclosure is directed to structured covers including an expanse, a structure member, and a hook. The hook is coupled to a first end of the structure member. The hook is configured to selectively couple to a coupling member to bound the expanse in a defined configuration defined at least in part by the structure member. In some examples, the structured cover includes a plurality of structure members, a plurality of mounting points, a channel layer, a crimp, and/or a reinforcing layer.

### BRIEF DESCRIPTION OF THE DRAWINGS

FIG. 1 is a perspective view of a first embodiment of a structured cover covering a box with hooks securing the cover in place by coupling to mounting points on the structured cover.

FIG. 2 is a front elevation view of the structured cover shown in FIG. 1 depicting structure members extending through channel layers in a lattice pattern with hooks and mounting points coupled to ends of the structure members.

FIG. 3 is a rear elevation view of the structured cover shown in FIG. 1 depicting canvas reinforcing layers opposite die channel layers

FIG. 4 is a close up view of a structure member extending through a channel layer with a hook on one end and and a mounting point on the other end.

FIG. 5 is a view of the hook shown in FIG. 1 separated from the structure member to demonstrate that the hook is selectively removable.

FIG. 6 is a front elevation view of a second embodiment of a structured cover depicting bungie cord structure members extending through channel layers arranged in a X-configuration.

FIG. 7 is a rear elevation view of the structured cover shown in FIG. 6 depicting reinforcing layers arranged in a complementary X-configuration.

### DETAILED DESCRIPTION

The disclosed structured covers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations arc contemplated for different applications and design considerations; however, for the sake of brevity, each and every contemplated variation is not individually described in the following detailed description.

Throughout the following derailed description, examples of various structured covers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to die specific portrayal of a related feature in any given figure or example.

Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, bur may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Structured Covers

With reference to the figures, structured covers will now be described. The structured covers discussed herein function to cover items to selectively conceal them or to selectively isolate them from external environments, such as rain, wind, or sunlight. Another function of the structured covers is to closely conform to the shape of the items being covered. In addition, the structured covers described in this document function to conveniently secure to external mounting points.

The reader will appreciate from the figures and description below that the presently disclosed covers address many of the shortcomings of conventional covers. For example, unlike existing covers, the covers described herein maintain a configuration closely conforming to the shape of the items they arc covering. The presently disclosed covers closely conform to the shape of items without requiring accessory cords or fasteners, which can be awkward to use or not readily available.

In addition, the covers described herein secure to external mounting points easily and effectively in contrast to conventional covers. Conveniently, the present covets do not require one to use accessory cords or fasteners to secure them in place, which may not be convenient to use, available, or compatible to secure the cover to a desired mounting point.

Another improvement over conventional covers is the currently described covers' ability to distribute tension and compression forces of structural members over a wider area of the cover. By not relying on a relatively small number of accessory cords or fasteners, the present covers avoid exerting tension and compression forces at a few localized points on the cover, such as along the outer edges, on one or more comers, or across the cover in a concentrated line. As a result, the structural members described in this document are able to exert requisite tension and/or compression forces necessary to secure the cover in position, such as in windy environments, over a relatively wide area to avoid tearing or otherwise damaging the cover or the item being covered.

Contextual Details

Ancillary features relevant to the structured covers described herein will first be described to provide context and to aid the discussion of the structured covers.

Items

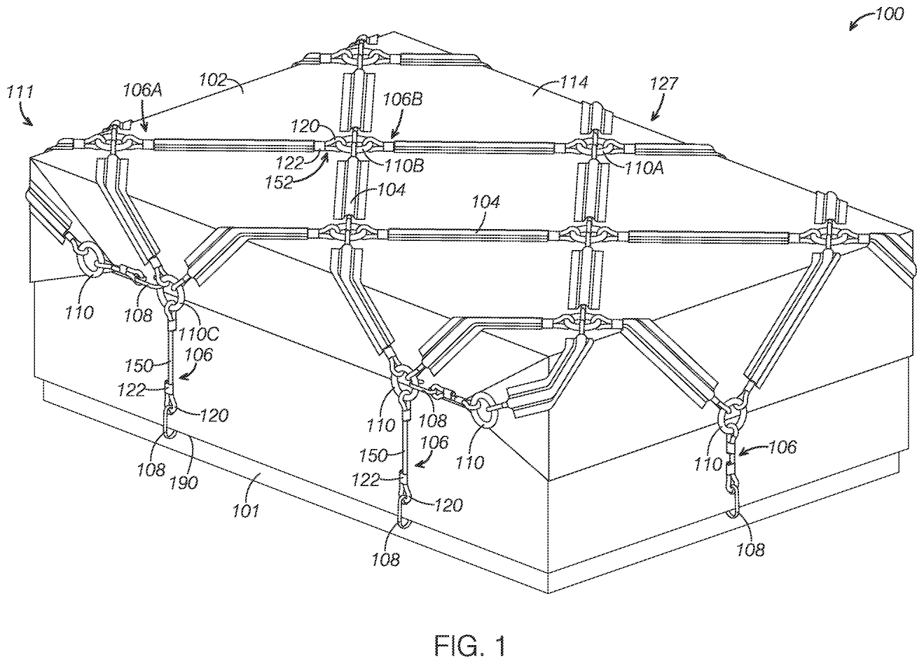

Various items may be covered by the covers or tarps described herein. Suitable items include household goods, tools, building materials, furniture, and storage containers. The item may be anything that benefits from being covered. For example, something that benefits from being selectively concealed and/or selectively isolated them from external conditions, such as rain, wind, or sunlight. The items may be a variety of different shapes and sizes. In FIG. 1, an item 101 in the form of a box is depicted.

Structured Cover Embodiment One

With reference to FIGS. 1-5, a structured cover 100 will now be described as a first example of a structured cover. As shown in FIGS. 1-3, structured cover 100 includes an expanse 102 and a plurality of structure members 106, hooks 108, mounting points 110, channel layers 104, and reinforcing layers 112.

In other examples, the structured cover includes fewer components than depicted in the figures. For example, some cover examples do not include reinforcing layers or hooks. In some cover examples, fewer channel layers, structure members, mounting points, hooks, and/or reinforcing layers are included than are depicted in FIGS. 1-5.

In certain examples, the structured cover includes additional or alternative components than depicted in the figures. For example, the cover may include a pouch or container tor storage or padding to cushion the item covered. In some examples, the cover includes a lock mechanism to secure the cover.

Expanse

Expanse 102 functions to cover items and to support other components of cover 100. Expanse 102 is pliable, tear resistant, and water resistant. However, the expanse need not be tear resistant and/or water resistant in all examples.

In the present example, expanse 102 is an expanse of a fabric material. In particular, expanse 102 is comprised of tarpaulin. Many other materials are suitable as well, such as canvas, polyester, polyethylene, or other polymers. In some examples, the expanse material includes a coating of polyurethane or other polymer. The expanse may be comprised of any currently known or later developed material suitable for cover applications.

As can be seen in FIGS. 1-3, expanse 102 is a planar member having a front face 114 and a rear face 116 opposite front face 114. In the present example, expanse 102 is rectangular, but may be any suitable shape, including circular, oval, triangular, square, another regular polygon, or an irregular shape. In some examples, the shape of the expanse is complementarily configured for a particular item or class of items.

Structure Members

The structure members (denoted generally with reference number 106) function to support, shape, and secure expanse 102. In particular, structure members 108 function to bend expanse 102 into shapes conforming to the item being covered. In the present example, structure members 108 conform the shape of expanse 102 to item 101 when tension is applied to structure members 106 around item 101.

In addition to helping expanse 102 conform to the shape of item 101, structure members 106 support expanse 102 and give it structure to resist crumpling or deforming when acted on by external forces, such as wind, impacts, or the item tilting or shifting within the cover. Structure members 106 cooperate with hooks 108 to secure expanse 102 to an external structure or mounting point, such as edge 190 shown in FIG. 1.

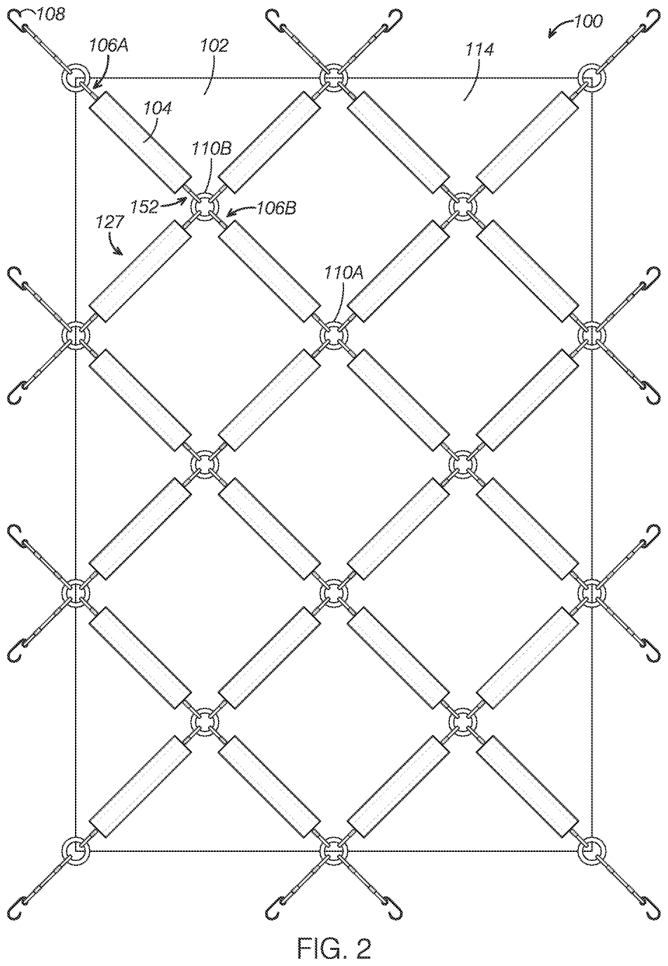

Structure members 106 include a first structure member 106A and a second structure member 106B. The reader can see in FIGS. 1 and 2 that second structure member 106B is spaced from first structure member 106A. As shown in FIGS. 1 and 2, the plurality of structure members defines a lattice arrangement 127 in the present example. However, a wide variety of other arrangements are contemplated.

The structure members may be any currently known or later developed type of structure member. The reader will appreciate that a variety of structure member types exist and could be used in place of the structure members shown in the figures. In addition to the types of structure members existing currently, it is contemplated that the structured covers described herein could incorporate new types of structure members developed in the future.

The number of structure members in the structured cover may be selected to meet the needs of a given application. The reader should appreciate that the number of structure members may be different in other examples than is shown in the figures. For instance, some structured cover examples include additional or fewer structure members than described in the present example.

The size and shape of the structure members may be varied as needed for a given application. In some examples, the structure members are larger relative to the other components than depicted in the figures. In other examples, the structure members are smaller relative to the other components than depicted in the figures. Further, the reader should understand that the structure members and the other components may all be larger or smaller than described herein while maintaining their relative proportions.

The structure members may be composed of any currently known or later developed material suitable tor their intended applications. Suitable materials include metals, polymers, ceramics, wood, and composite materials.

Structure Member Details

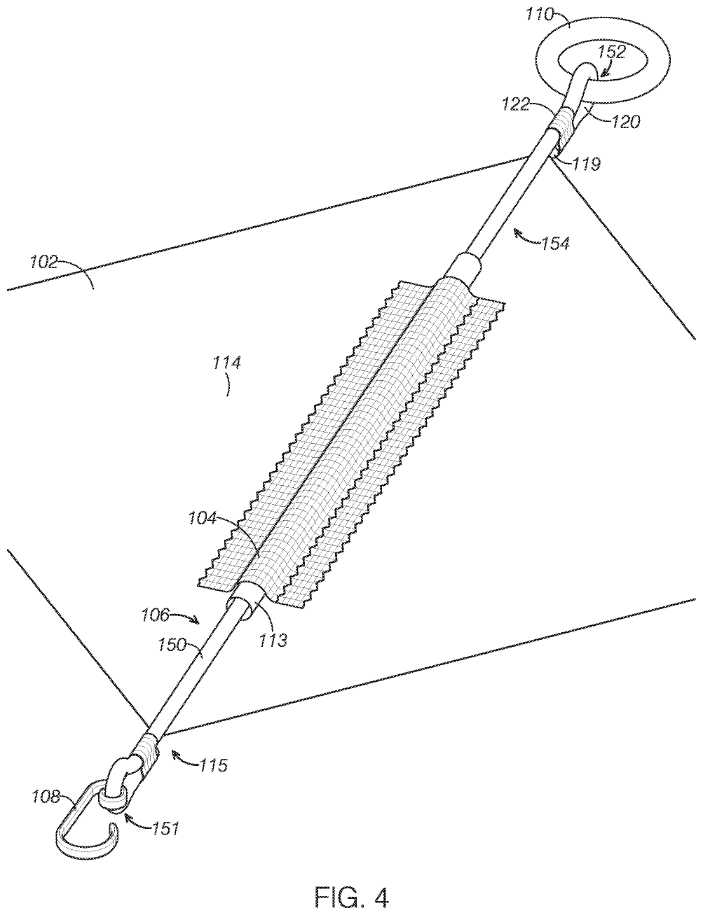

With reference to FIG. 4, structure member 106 is elongated and includes an elastic component. However, in some examples the structure members arc not elastic. As shown in FIG. 4, structure member 106 is an elongate tension bearing member.

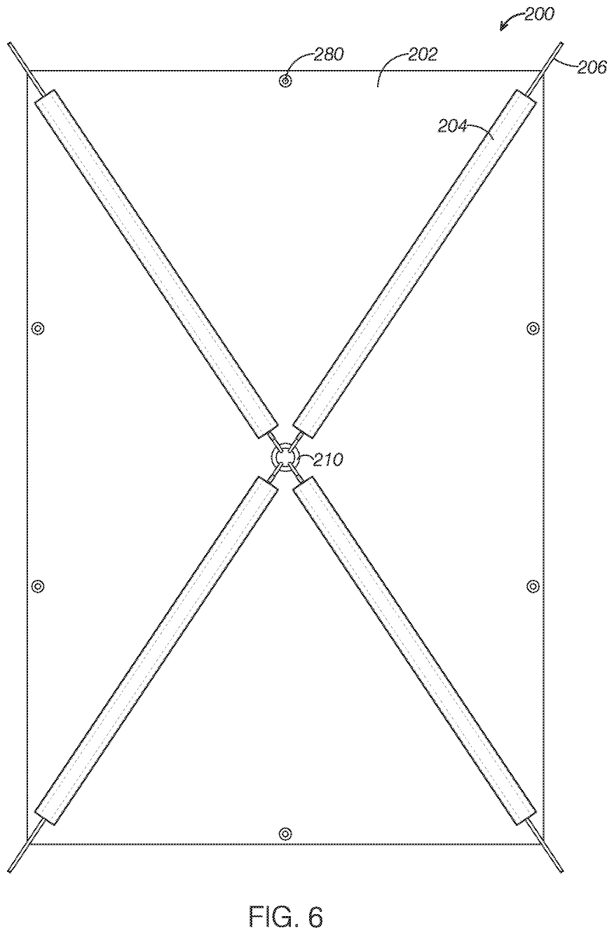

In more detail, with reference to FIG. 4, structure member 106 includes a rigid rube 113, an elastic cord 150, a first end 151, and a second end 152. An alternative structure member is depicted in FIG. 6. In FIG. 6, structure member 206 is a bungee cord. As shown in FIG. 4, structure member 106 defines a terminal end 153 and a body portion 154.

With reference to FIG. 4, elastic cord 150 is disposed in rigid tube 113. A coupling portion 115 of elastic cord 150 extends beyond rigid tube 113. As shown in FIG. 4, body portion 154 extends to terminal end 153.

First end 151 may be disposed proximate a boundary of expanse 102 or within the boundaries of expanse 102. As shown in FIG. 4, first end 151 is defined on coupling portion 115 of elastic cord 150.

With reference to FIG. 4, second end 152 is opposite first end 151. The reader can see in FIG. 4 that second end 152 defines a loop 120.

Loop 120 functions to engage mounting point 110. As depicted in FIG. 4, loop 120 is defined by bending elastic cord 150 upon itself proximate terminal end 119 and securing terminal end 119 to body portion 154 with a crimp 122.

The crimp may be any currently known or later developed type of crimp. The reader will appreciate that a variety of crimp types exist and could be used in place of the crimp shown in the figures. In addition to the types of crimps existing currently, it is contemplated that the structured covers described herein could incorporate new types of crimps developed in the future.

The size of the crimp may be varied as needed for a given application. In some examples, the crimp is larger relative to the other components than depicted in the figures. In other examples, the crimp is smaller relative to the other components than depicted in the figures. Further, the reader should understand that the crimp and the other components may all he larger or smaller than described herein while maintaining their relative proportions.

Hooks

Hooks 108 function to selectively couple structure members 106 to external mounting points of an external structure or to mounting points 110 overlying expanse 102 in various positions. When the hooks selectively couple structure members 106 to external mounting points, cover 100 becomes secured to the external structure, such as a building, a vehicle, a trailer, or a fence. The reader can see in FIG. 4 that hook 108 is coupled to first end 151 of structure member 106.

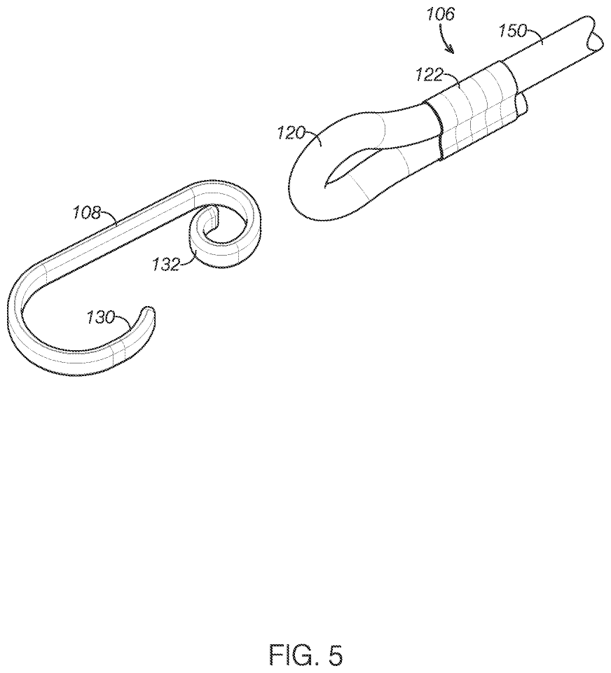

With reference to FIGS. 1 and 5, hook 108 is complementarily configured with internal and external mounting points to selectively mount to the mounting points. As depicted in FIG. 1, hook 108 is configured to selectively couple to a selected mounting point, defined as a coupling member 110C, to bound expanse 102 in a defined configuration 111. Defined configuration 111 is defined at least in part by structure member 106.

As shown in FIG. 1, when hooks 108 selectively couple to mounting points at various positions on expanse 102 or external structures, cover 100 adopts a shape defined by support member 106 coupling to the selected mounting point. In particular, cover 100 may adopt a shape more closely conforming to the shape of the item being covered, such as depicted in FIG. 1. Support member 106 bending around the item and coupling to the selected mounting point functions to correspondingly bend expanse 102 around the item.

Hooks 108 removably attach to loops 120. As shown in FIG. 5, hook 108 includes a major crook 150 and a minor crook 132. Minor crook 132 is complementarily configured with loop 120 to selectively and removably couple with loop 120. Major crook 130 is complementarily configured with mounting points 110 to selectively and removably couple with a selected mounting point 110. Major crook 130 is also configured to selectively and removably couple with a mounting point of an external structure or to another hook.

The hooks may be any currently known or later developed type of hook. The reader will appreciate that a variety of hook types exist and could be used in place of the hooks shown in the figures. In addition to the types of hooks existing currently, it is contemplated that the structured covers described herein could incorporate new types of hooks developed in the future.

The number of hooks in the structured cover may be selected to meet the needs of a given application. The reader should appreciate that die number of hooks may be different in other examples than is shown in the figures. For instance, some structured cover examples include additional or fewer hooks than described in the present example.

The size and shape of the hooks may be varied as needed for a given application. In some examples, the hooks are larger relative to the other components than depicted in the figures. In other examples, the hooks are smaller relative to the other components than depicted in the figures. Further, the reader should understand that the hooks and the other components may all be larger or smaller than described herein while maintaining their relative proportions.

In the present example, the hooks are composed of metal. However, the hooks may be composed of any currently known or later developed material suitable for the applications described herein for which it is used. Suitable materials include metals, polymers, ceramics, wood, and composite materials.

Mounting Points

Plurality of mounting points 110 function to provide places for hooks 108 to selectively couple. Couplings hook to a mounting point serves to define the shape of structured cover 100.

Plurality of mounting points 110 includes a first mounting point 110A and a second mounting point 110B. With reference to FIGS. 1 and 2, second mounting point 110B is spaced from first mounting point 110A. As shown in FIGS. 1, 2, and 4, coupling member 110C is one of the mounting points in plurality of mounting points 110.

As depicted in FIG. 4, mounting point 110 defines a ring passing through loop 120 of second end 108.

As shown in FIGS. 1 and 2, mounting points 110, including first mounting point 110A, second mounting point 110B, and coupling member 110C, overlie expanse 102. In particular, the mounting points are coupled to structure members, which are held in place over expanse 102 by channel layers 104. As depicted in FIGS. 1 and 2, mounting points 110 overlie expanse 102 at vertices of adjacent structure members 110.

As shown in FIG. 2, second mounting point 110B links together first structure member 106A and second structure member 106B. The reader can see in FIG. 2 that first mounting point 110A is coupled to second structure member 106B on an opposite end of second structure member 106B from second mounting point 110B. As depicted in FIGS. 1 and 2. second mounting point 110B is coupled to second end 152 of first structure member 106A.

The mounting points may be any currently known or later developed type of mounting point. The reader will appreciate that a variety of mounting point types exist and could he used in place of the mounting points shown in the figures. In addition to the types of mounting points existing currently, it is contemplated that the structured covers described herein could incorporate new types of mounting points developed in the future.

The number of mounting points in the structured cover may be selected to meet the needs of a given application. The reader should appreciate that the number of mounting points may be different in other examples than is shown in the figures. For instance, some structured cover examples include additional or fewer mounting points than described in the present example.

The shape of the mounting points may be adapted to be different than rite specific examples shown in the figures to suit a given application. For example, one or more of the mounting points may include a face having the shape of a regular or irregular polygon, such as a circle, oval, triangle, square, rectangle pentagon, and the like. Additionally or alternatively, one or more of the mounting points may include a face having an irregular shape. In three dimensions, the shape of the mounting points may be a sphere, a pyramid, a cone, a cube, and variations thereof, such as a hemisphere or a frustoconical shape.

The size of the mounting points may be varied as needed for a given application. In some examples, the mounting points are larger relative to the other components than depicted in the figures. In other examples, the mounting points are smaller relative to the other components than depicted in the figures. Further, the reader should understand that the mounting points and the other components may all be larger or smaller than described herein while maintaining their relative proportions.

In the present example, the mounting points are composed of metal. However, the mounting points may he composed of any currently known or later developed material suitable for the applications described herein for which they arc used. Suitable materials include metals, polymers, ceramics, wood, and composite materials.

Channel Layer

The role of channel layer 104 is to support and orient structure members 106 on expanse 102. In the example shown in FIGS. 1 and 2, channel layers 104 are arranged in a diamond pattern across front face 114 of expanse 102. However, many other arrangements are contemplated, such as rectilinear configurations, cross configurations, circular configurations, triangular configurations, and irregular configurations. An example of an alternative configuration, an X-configuration, is show in FIG. 6.

As shown in FIGS. 2 and 4, channel layer 114 defines a channel through which structure member 106 extends. The reader can see in FIGS. 2 and 4 that structure member 106 is disposed between front face 114 and channel layer 104 in the channel. In the present example, structure member 106 is bounded closely on lateral sides by the channel with freedom to move longitudinally to insert or retract structure member 106 into the channel. The size of the channel is selected to allow mounting points 110 and loops 120 to pass through the channel.

With reference to FIGS. 1, 2, and 4, channel layer 104 is secured to front face 114. The reader can see in FIG. 4 that channel layer 104 is also secured to reinforcing layer 112 in addition to front face 114. Channel layer 104 securing to reinforcing layer 112 helps reinforce channel layer 104 coupling to front face 114.

The number of channel layers in the structured cover may be selected to meet the needs of a given application. The reader should appreciate that the number of channel layers may be different in other examples than is shown in the figures. For instance, some structured cover examples include additional or fewer channel layers than described in the present example.

The size of the channel layer may be varied as needed for a given application. In some examples, the channel layer is larger relative to the other components than depicted in the figures. In other examples, the channel layer is smaller relative to the other components than depicted in the figures. Further, the reader should understand that the channel layer and the other components may all be larger or smaller than described herein while maintaining their relative proportions.

In the present example, the channel layer is composed of a strong canvas material often used for duffle bags and is resistant to wear and tearing. However, the channel layer may be composed of any currently known or later developed material suitable for the applications described herein for which it is used. Suitable materials include metals, polymers, ceramics, wood, and composite materials.

Reinforcing Layer

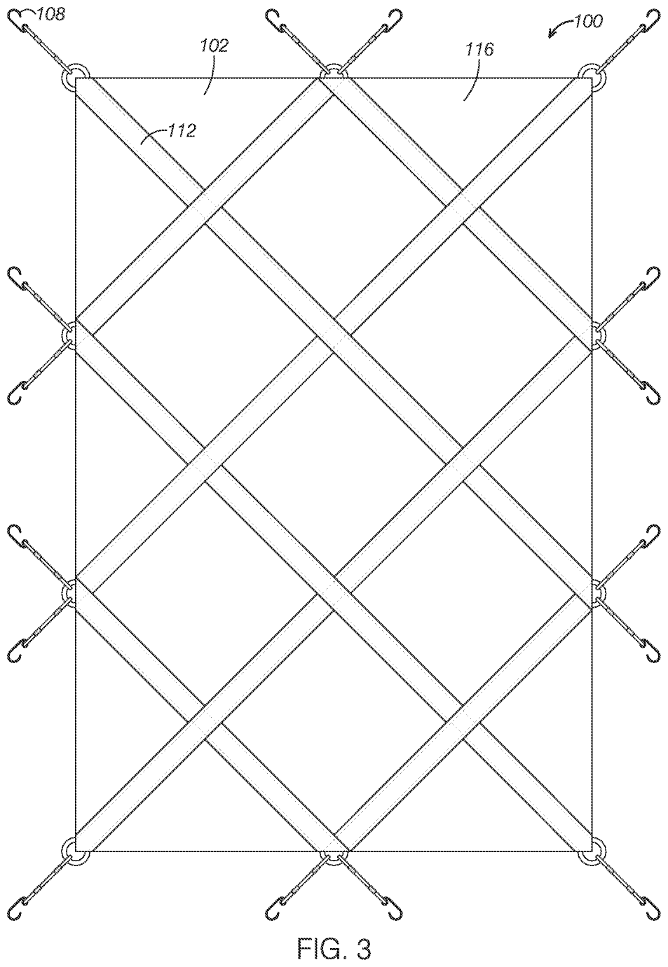

Reinforcing layer 112 functions to reinforce channel layers 104 sewn to expanse 102. As shown in FIG. 3, reinforcing layers 112 serve as backing layers sewn to rear face 116. Reinforcing layers 112 are secured to rear face 116 in positions corresponding to the positions of channel layers 104. For example, as depicted in FIG. 3, reinforcing layer 112 is secured to rear face 116 of expanse 102 in a position opposite channel layer 104.

When reinforcing layers 112 are positioned to correspond with the positions of channel layers 104 on opposite faces of expanse 102, channel layers 104 may be sewn to both expanse 102 and to reinforcing layers 112. Sewing channel layers 104 to reinforcing layers 112 more durably secures channel layers 104 to expanse 102.

The reinforcing layers may be formed from any currently known or later developed material suitable for reinforcing the channel layers and the expanse. In the present example, reinforcing layers 130 are a canvas material. In particular, reinforcing layers 130 are formed from the same material as channel layers 128. In other examples, the reinforcing layers are formed from different materials than the channel layers.

The reinforcing layers may extend different lengths to suit different applications. In some examples, the reinforcing layers extend over substantially the same length as the channel layers In other examples, the reinforcing layers extend over a portion of the length of the channel layers. In certain examples, such its shown in FIG. 3, reinforcing layers 130 extend to lengths exceeding the length of channel layers 128.

Additional Embodiments

The discussion will now focus on an additional cover embodiment. The additional embodiment includes many similar or identical features to cover 100. Thus, for the sake of brevity, each feature of the additional embodiment below will not be redundantly explained. Rather, key distinctions between the additional embodiment and cover 100 will be described in detail and the reader should reference the discussion above for features substantially similar between the different cover examples.

### Second Embodiment

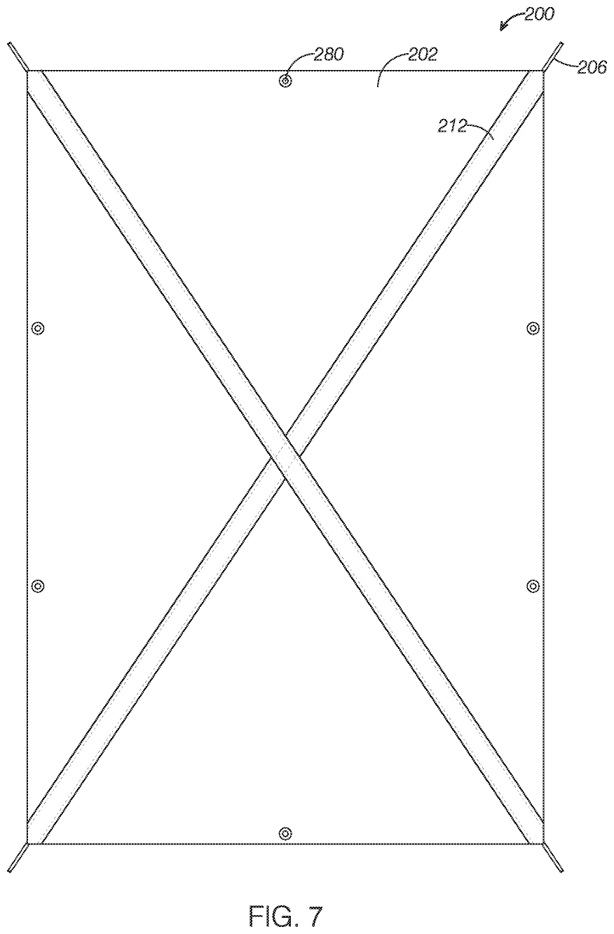

Turning attention to FIGS. 6 and 7, a second example of a cover, cover 200, will now be described. As can be seen in FIGS. 6 and 7, cover 200 includes an expanse 202, four channel layers 204, two structure members 206, four hooks (not pictured), a mounting point 210, and two reinforcing layers 212.

A distinction between cover 200 and cover 100 is that cover 200 includes four channel layers 204 rather than a plurality of channel layers 104. Channel layers 204 are longer than channel layers 104, but are constructed in substantially the same manner. In addition, cover 200 includes two structure members 206 and a single mounting point 210 rather than a plurality of support members 106 and a plurality of mounting points 110.

Another distinction between the covers is that channel layers 204 and structure members 206 are oriented in an X-configuration rather than lattice configuration 127. In the X-configuration, mounting point 210 functions to guide structure members 206 where they cross each other. Mounting point 210 also functions to provide an anchor for the hooks to engage when conforming expanse 201 to the shape of a given item.

The reader can see in FIGS. 6 and 7 that expanse 202 defines a plurality of body mounting points 280 to which the hooks or other members may secure. As shown in FIGS. 6 and 7, body mounting points 280 are defined along edges of expanse 202. In the examples shown in FIGS. 6 and 7, body mounting points 280 are metal eyelets.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should he understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A structured cover, comprising;
an expanse of a flexible material, the expanse including:
a front face; and
a rear face;
a first structure member operatively coupled to the front face of the expanse, the first structure member including;
a first end disposed proximate a boundary of the expanse; and
a second end opposite the first end;
a first hook coupled to the first end of first structure member;
wherein the first hook is configured to selectively couple to a coupling member to bound the expanse in a defined configuration defined at least in part by the first structure member.

2. The structured cover of claim 1, wherein the first structure member is elongated.

3. The structured cover of claim 2, wherein the first structure member is an elongate tension bearing member.

4. The structured cover of claim 3, wherein the first structure member is elastic.

5. The structured cover of claim 4, wherein the first structure member is a bungee cord.

6. The structured cover of claim 2, wherein the first structure member includes:
a rigid tube; and
an elastic cord disposed in the rigid tube with a coupling portion extending beyond the rigid tube;
wherein the first end is defined on the coupling portion of the elastic cord.

7. The structured cover of claim 1, further comprising a first mounting point overlying the expanse.

8. The structured cover of claim 7, wherein the first mounting point is coupled to the second end of the first structure member.

9. The structured cover of claim 8, wherein:
the second end defines a loop; and
the mounting point defines a ring passing through the loop of the second end.

10. The structural cover of claim 9, wherein:
the first structure member defines:
a terminal end and;
a body portion extending to the terminal end; and
the loop is defined by bending the first structure member upon itself proximate the terminal end and securing the terminal end to the body portion.

11. The structured cover of claim 10, further comprising a crimp securing the terminal end to the body portion.

12. The structured cover of claim 1, further comprising a plurality of structure members, the plurality of structure members including:
the first structure member; and
a second structure member spaced from the first structure member.

13. The structured cover of claim 12, wherein:
the structured cover further comprises a plurality of mounting points overlying the expanse, the plurality of mounting points including:
a first mounting point; and
a second mounting point spaced from the first mounting point,
wherein the first hook is complementarily configured with the mounting points to selectively mount to the mounting points; and
wherein the coupling member is one of the mounting points in the plurality of mounting points.

14. The structured cover of claim 13, wherein the second mounting point links together the first structure member and the second structure member.

15. The structured cover of claim 14, wherein the first mounting point is coupled to the second structure member on an opposite end of the second structure member from the second mounting point.

16. The structured cover of claim 13, wherein the structure members are operatively coupled to the expanse in a lattice arrangement.

17. The structured cover of claim 16, wherein the mounting points overlie the expanse at vertices of adjacent structure members.

18. The structured cover of claim 1, further comprising a channel layer secured to the front face, the channel layer defining a channel through which the first structure member extends between the front face and the channel layer.

19. The structured cover of claim 17, further comprising a reinforcing layer secured to the rear face of the expanse in a position opposite the channel layer.

20. The structured cover of claim 18, wherein the channel layer is secured to the reinforcing layer in addition to the front face to reinforce the channel layer coupling to the front face.
